(19) United States
(12) Patent Application Publication
(10) Pub. No.: US 2019/0003959 A1
(43) Pub. Date: Jan. 3, 2019

(54) BLIND SEPARATION BASED HIGH ACCURACY PERSPECTIVE DETECTION METHOD FOR MULTILAYER COMPLEX STRUCTURE MATERIAL

(71) Applicant: Guangdong University of Technology, Guangzhou City (CN)

(72) Inventors: Shengli Xie, Guangzhou City (CN); Yulei Bai, Guangzhou City (CN); Yanzhou Zhou, Guangzhou City (CN); Zhaoshui He, Guangzhou City (CN); Guoxu Zhou, Guangzhou City (CN); Kan Xie, Guangzhou City (CN); Haochuan Zhang, Guangzhou City (CN)

(21) Appl. No.: 15/638,506

(22) Filed: Jun. 30, 2017

(51) Int. Cl. G01N 21/17; G06F 17/14

(52) U.S. Cl. CPC G01N 21/1717; G06F 17/142

(57) ABSTRACT

The present disclosure discloses a blind separation based high accuracy perspective detection method for a multilayer complex structure material. The method is achieved through blind separation of single channel periodic signals and frequency modulation interference of laser wave numbers. In this method, time series interference images captured by a photodetector are subjected to zero mean normalization; a vector Θ of amplitude, frequency and phase field, which is to be solved and reflects characteristics of each interface in the multilayer complex-structure material, is created and is solved using a mathematical optimization method; a phase field distribution of the vector Θ is finally extracted and is subjected to phase unwrapping, to realize high accuracy detection on an internal distribution of the multilayer complex structure material. The present disclosure has advantages that limitation on a Nyquist depth measurement resolution caused by a limited laser wave number frequency sweep range is overcome, and high accuracy distribution conditions of each interface layer in the multilayer complex-structure material can be acquired.

### TECHNICAL FIELD

The present disclosure relates to a blind separation based high accuracy perspective detection method for a multilayer complex structure material, which realizes high accuracy perspective detection on a distribution of the complex structure material based on blind separation of single channel periodic signals and frequency modulation interference of laser wave numbers, and belongs to the fields such as ultra-precision measurement, photoelectric detection etc.

### BACKGROUND

Frequency modulation interference and detection of laser wave numbers can achieve non-destructive high-accuracy perspective detection of a distribution within a multilayer complex structure material (for example, resin-based composite material) with a detection accuracy up to ±10 nm, and have a broad application prospect. When a laser wave number frequency modulation interference system is used to detect a subject, various interface layers in the subject correspond to sinusoidal signals at different frequencies, and a detection result is a superposition of these sinusoidal signals at different frequencies. In order to obtain a contour of each interface layer of the subject, it needs to perform blind separation on signals of various pixels of the detection result. A commonly used detection method is the Fourier transform-based signal separation method. This method is to perform Fourier transform on the detection result along the time axis, and realizes signal separation by virtue of non-overlapping features of the sinusoidal signals at different frequencies in the frequency domain, so as to realize inter-layer distribution detection of the multilayer complex structure material, i.e., a peak of an amplitude in the frequency domain corresponds to a sinusoidal signal of an interface layer thereof, and a phase field at the peak corresponds to a distribution of the interface layer.

However, the accuracy of the Fourier transform method has its limitation since the laser wave number frequency modulation range is limited, and when positions of two interface layers in the subject in the depth direction are close to each other, a result of the Fourier transform has a serious spectral aliasing phenomenon, resulting in failure of separation of interference signals of the two layers and phase fields thereof. How to accurately and effectively separate an interference signal of each interface layer in the subject in a condition of a limited laser frequency modulation range is one of the urgent problems to be solved currently in the laser wave number frequency modulation interference detection system.

### SUMMARY

In view of the above technical problems, the present disclosure aims to overcome the above-mentioned bottleneck of the Fourier transform-based method and realize high accuracy detection of the distribution of the multilayer complex structure material based on the laser interference of single channel periodic signal blind separation, and proposes a blind separation based high accuracy perspective detection method for a multilayer complex structure material, which separates an interference signal of each interface layer of a subject according to single channel observation data. The new method is particularly suitable for detection when interface layers of the multilayer complex structural material in the depth direction are close to each other.

In order to achieve the above purpose, the present disclosure proposes the following technical solutions.

A blind separation based high accuracy perspective detection method for a multilayer complex structure material is provided. It realizes high accuracy perspective detection on a distribution of the complex structure material based on blind separation of single channel periodic signals and frequency modulation interference of laser wave numbers. The method comprises steps of:

1) centralizing (performing zero mean normalization on) an interference detection image sequence collected by a photodetector:

$$I ( x , y , \frac{n - 1}{N - 1} \cdot Δ k ) = {\sum }_{p = 1}^{M - 1} {\sum }_{q = p + 1}^{M} {A}_{pq} ( x , y ) \cdot cos [ 2 π \cdot {f}_{pq} ( x , y ) \cdot \frac{n - 1}{N - 1} \cdot Δ k + {φ}_{pq} ( x , y ) ] , \\ {A}_{pq} ( x , y ) = 2 \cdot \sqrt{{I}_{p} ( x , y ) \cdot {I}_{q} ( x , y )} , \\ {f}_{pq} ( x , y ) = \frac{{A}_{pq} ( x , y )}{π} , \\ {φ}_{pq} ( x , y ) = 2 \cdot k ( 1 ) \cdot {A}_{pq} ( x , y ) + {ϕ}_{pq 0} ( x , y ) ,$$

where x and y are spatial coordinates of the photodetector, Δk is a laser frequency modulation range, k(1) is a laser initial wave number, Iₚ and I_{q} are reflection intensities of p^{th} and q^{th} layers of the measured material Λ_{pq} is an optical path difference between the p^{th} and q^{th} layers, φ_{pq0} is an initial phase difference between the p^{th} and q^{th} layers, and n=1, 2, . . . , N where N is a total number of pictures captured by the photodetector. For convenience of description, the spatial coordinates x and y in the equations are omitted. For example, A_{pq}(x, y) is abbreviated as A_{pq}, f_{pq}(X, y) is abbreviated as f_{pq}, and Φ_{pq}(x, y) is abbreviated as Φ_{pq}.

2) in order to solve a sinusoidal signal of each interface layer, determining an amplitude, a frequency and a phase field of each sinusoidal signal, to establish a vector Θ to be solved as follows:

Θ={A₁₂, . . . ,A_{pq}, . . . ,A_{(M-1)M};f₁₂, . . . ,f_{pq}, . . . ,f_{(M-1)M};ϕ₁₂, . . . ,ϕ_{pq}, . . . ,ϕ_{(M-1)M}},
3) obtaining the vector Θ to be solved by performing mathematical optimization on detection data in the wave number field with a known mathematical model for an interference signal, as follows:

$${min}_{Θ} J ( Θ ) = {min}_{Θ} {‖ \hat{I} ( \frac{n - 1}{N - 1} \cdot Δ k ) - {\sum }_{p = 1}^{M - 1} {\sum }_{q = p + 1}^{M} {A}_{pq} \cdot cos ( 2 π \cdot {f}_{pq} \cdot \frac{n - 1}{N - 1} \cdot Δ k + {φ}_{pq} ) ‖}_{2}^{2} ,$$

where J represents a cost function, and Î represents an interference signal collected by a digital camera. The above equations may be solved using the quasi-Newton optimization method.

4) extracting an amplitude A_{pq}, a frequency f_{pq} and a phase field ϕ_{pq} of a signal of each interface layer of the subject from the vector Θ, to realize separation of signals of various interface layers, and performing phase unwrapping on the phase field of each interface layer to obtain a distribution of the interface layer.

Further, in step 1), a single photodetector is used to collect the interference detection image sequence, wherein the photodetector comprises a Charge Coupled Device (CCD) digital camera and a Complementary Metal Oxide Semiconductor (CMOS) digital camera.

Advantageous effects of the present disclosure are as follows.

The present disclosure can accurately and effectively separate an interference signal of each interface layer in the subject in a condition that the laser frequency modulation range is limited, overcome the Nyquist depth detection resolution due to the limited laser wave number frequency sweep range, effectively separate the interference signal of each interface layer in the subject, accurately give a distribution of each interface layer, and has a high application value.

### BRIEF DESCRIPTION OF THE DRAWINGS

FIG. 1 is a laser wave number frequency sweep interference detection system which is an implementation object of the present disclosure;

FIG. 2 is a structural diagram of a four-layer transparent acrylic plate which is a detected object of the present disclosure;

FIG. 3 is a single channel time-domain interference signal captured by a digital camera at a single pixel;

FIG. 4 is a wrapped phase field of a separated signal S12;

FIG. 5 is a wrapped phase field of a separated signal S13;

FIG. 6 is a plot of a distribution of an S₂ layer; and

FIG. 7 is a plot of a distribution of an S₃ layer;

wherein 1-S₁ layer, 2-S₂ layer, 3-S₃ layer and 4-S₄ layer.

### DETAILED DESCRIPTION

The technical solutions in the embodiments of the present disclosure will be clearly and completely described below in conjunction with the detailed description and the accompanying drawings of the present disclosure, and it is obvious that the described embodiments are merely a part of the embodiments of the present disclosure instead of all the embodiments. All other embodiments obtained by those of ordinary skill in the art based on the embodiments of the present disclosure without making creative work are within the scope of the present disclosure.

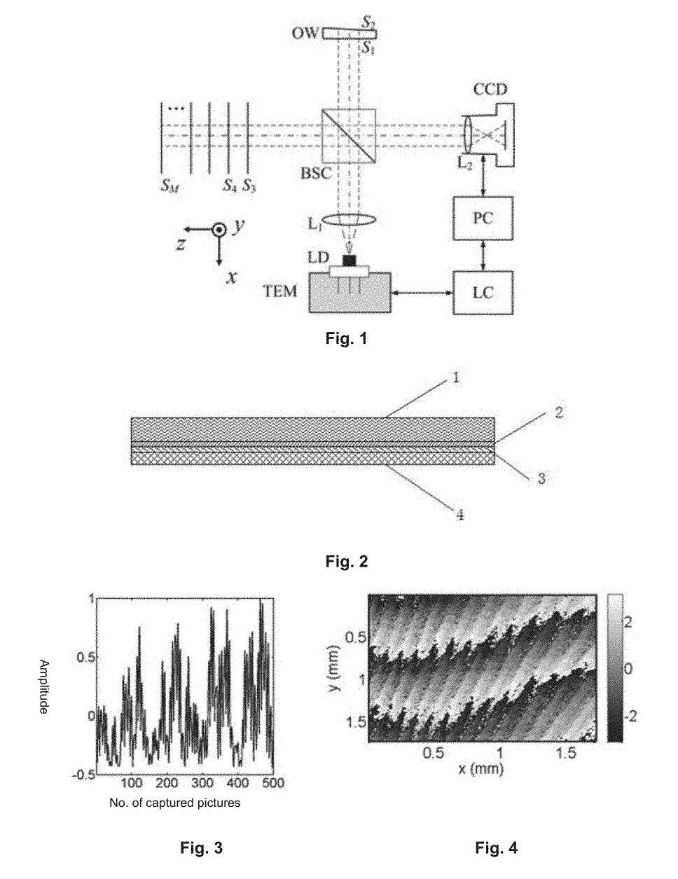

FIG. 1 is a laser wave number frequency sweep interference detection system which is an implementation object of the present disclosure; and FIG. 2 is a four-layer transparent acrylic plate which is a detected object of the present disclosure, wherein the four layers correspond to an S₁ layer, an S₂ layer, an S₃ layer and an S₄ layer respectively, and a distance between the S₂ layer and the S₃ layer is 90 μm. The present disclosure relates to a single channel periodic signal blind separation and laser wave number frequency modulation interference based detection method for a multilayer complex structure material, comprising steps of:

(1) performing zero mean normalization on an interference detection signal collected by a Charge Coupled Device (CCD) photodetector as follows:

$$I ( \frac{n - 1}{N - 1} \cdot Δ k ) = {\sum }_{p = 1}^{5} {\sum }_{q = p + 1}^{6} {A}_{pq} \cdot cos ( 2 π \cdot {f}_{pq} \cdot \frac{n - 1}{N - 1} \cdot Δ k + {φ}_{pq} ) , \\ {A}_{pq} = 2 \cdot \sqrt{{I}_{p} \cdot {I}_{q}} , {f}_{pq} = \frac{{Λ}_{pq}}{π} , {φ}_{pq} = 2 \cdot k ( 1 ) \cdot {Λ}_{pq} + {ϕ}_{pq 0} ,$$

where Δk is a laser frequency modulation range, k(1) is a laser initial wave number, Iₚ and I_{q} are reflection intensities of p^{th} and q^{th} layers of a measured surface, Λ_{pq} is an optical path difference between the p^{th} and q^{th} layers, φ_{pq0} is an initial phase difference between the p^{th} and q^{th} layers, and n=1, 2, . . . , N where N is a total number of captured pictures. In a specific embodiment, Δk=1.209×10⁴ m⁻¹, k(1)=7.300×10⁶ m⁻¹ and N=800. FIG. 3 is a single channel intensity signal sequence captured by a CCD digital camera at a single pixel.

(2) in order to solve a sinusoidal signal of each interface layer, determining an amplitude, a frequency and a phase field, to establish a vector Θ to be solved as follows:

Θ={A₁₂, . . . ,A_{pq}, . . . ,A_{(M-1)M};f₁₂, . . . ,f_{pq}, . . . ,f_{(M-1)M};ϕ₁₂, . . . ,ϕ_{pq}, . . . ,ϕ_{(M-1)M}},

(3) obtaining the vector Θ to be solved by performing mathematical optimization on detection data in the wave number field with a known mathematical model of an interference signal, to obtain:

$${min}_{{A}_{pq} , {f}_{pq} , {φ}_{pq}} J ( Θ ) = {min}_{{A}_{pq} , {f}_{pq} , {φ}_{pq}} {‖ \hat{I} ( \frac{n - 1}{N - 1} \cdot Δ k ) - {\sum }_{p = 1}^{5} {\sum }_{q = p + 1}^{6} {A}_{pq} \cdot cos ( 2 π \cdot {f}_{pq} \cdot \frac{n - 1}{N - 1} \cdot Δ k + {φ}_{pq} ) ‖}_{2}^{2} ,$$

where J represents a cost function, and Î represents intensity collected by the COD digital camera. In a specific embodiment, firstly, an initial frequency value, a phase field and an initial amplitude in Θ are obtained respectively by using correlation matrix spectrum decomposition and fast Fourier transform. Finally, a solution of Θ is calculated according to the quasi-Newton iterative optimization method.

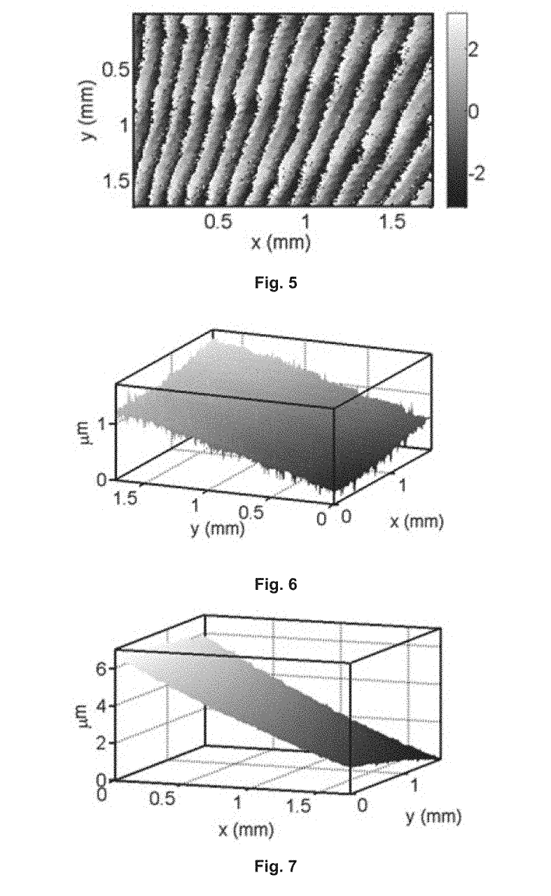

(4) extracting an amplitude A_{pq}, a frequency f_{pq} and a phase field ϕ_{pq} of a signal of each interface layer of the measured material from the vector Θ, to realize separation of signals of various interface layers, wherein FIGS. 4 and 5 are phase fields of the separated signals S₁₂ and S₁₃ of the present disclosure, and performing phase unwrapping on the phase field of the separated signal of each interface layer to obtain a distribution of the interface layer. FIGS. 6 and 7 are distributions of the S₂ and S₃ layers obtained according to the present disclosure.

The present disclosure discloses a blind separation based high accuracy perspective detection method for a multilayer complex structure material. The method is achieved through blind separation of single channel periodic signals and frequency modulation interference of laser wave numbers. In this method, time series interference images captured by a photodetector are subjected to zero mean normalization; a vector Θ of amplitude, frequency and phase field, which is to be solved and reflects characteristics of each interface in the multilayer complex-structure material, is created and is solved using a mathematical optimization method; a phase field distribution of the vector Θ is finally extracted and is subjected to phase unwrapping, to realize high accuracy detection on an internal distribution of the multilayer complex structure material. The present disclosure has advantages that limitation on a Nyquist depth measurement resolution caused by a limited laser wave number frequency sweep range is overcome, and high accuracy distribution conditions of each interface layer in the multilayer complex-structure material can be acquired.

In conclusion, the above embodiments and accompanying drawings are merely illustrative of the technical solutions of the present disclosure and are not restrictive. Although the present disclosure has been described in detail by way of the above embodiments, it will be understood by those skilled in the art that various changes can be made in forms and details without departing from the scope as defined by the appended claims of the present disclosure.

1. A blind separation based high accuracy perspective detection method for a multilayer complex structure material, which realizes high accuracy perspective detection on a distribution of the complex structure material based on blind separation of single channel periodic signals and frequency modulation interference of laser wave numbers, the method comprising steps of:
1) centralizing an interference detection image sequence collected by a photodetector;
2) in order to solve a sinusoidal signal of each interface layer, determining an amplitude, a frequency and a phase field of each sinusoidal signal, to establish a vector Θ to be solved as follows:
Θ={A₁₂, . . . ,A_{pq}, . . . ,A_{(M-1)M};f₁₂, . . . ,f_{pq}, . . . ,f_{(M-1)M};ϕ₁₂, . . . ,ϕ_{pq}, . . . ,ϕ_{(M-1)M}},
where subscripts p and q represent p^{th} and q^{th} interface layers of a subject respectively, A, f and ϕ represent an amplitude, a frequency and a phase field of a signal of each interface layer;
3) obtaining the vector Θ to be solved by performing mathematical optimization on detection data in the wave number field with a known mathematical model for an interference signal, as follows:
$${min}_{Θ} J ( Θ ) = {min}_{Θ} {‖ \hat{I} ( \frac{n - 1}{N - 1} \cdot Δ k ) - {\sum }_{p = 1}^{M - 1} {\sum }_{q = p + 1}^{M} {A}_{pq} \cdot cos ( 2 π \cdot {f}_{pq} \cdot \frac{n - 1}{N - 1} \cdot Δ k + {φ}_{pq} ) ‖}_{2}^{2} ,$$
where J represents a cost function, and Î represents an interference signal collected by a digital camera;
4) extracting an amplitude A_{pq}, a frequency f_{pq} and a phase field ϕ_{pq} of a signal of each interface layer of the subject from the vector Θ, to realize separation of signals of various interface layers, and performing phase unwrapping on the phase field of each interface layer to obtain a distribution of the interface layer.

2. The blind separation based high accuracy perspective detection method for a multilayer complex structure material according to claim 1, wherein in step 1), a single photodetector is used to collect the interference detection image sequence, wherein the photodetector comprises a Charge Coupled Device (CCD) digital camera and a Complementary Metal Oxide Semiconductor (CMOS) digital camera.

3. The blind separation based high accuracy perspective detection method for a multilayer complex structure material according to claim 1, wherein step 1) of centralizing the collected interference detection image sequence further comprises:
$$I ( x , y , \frac{n - 1}{N - 1} \cdot Δ k ) = {\sum }_{p = 1}^{M - 1} {\sum }_{q = p + 1}^{M} {A}_{pq} ( x , y ) \cdot cos [ 2 π \cdot {f}_{pq} ( x , y ) \cdot \frac{n - 1}{N - 1} \cdot Δ k + {φ}_{pq} ( x , y ) ] , \\ {A}_{pq} ( x , y ) = 2 \cdot \sqrt{{I}_{p} ( x , y ) \cdot {I}_{q} ( x , y )} , \\ {f}_{pq} ( x , y ) = \frac{{A}_{pq} ( x , y )}{π} , \\ {φ}_{pq} ( x , y ) = 2 \cdot k ( 1 ) \cdot {A}_{pq} ( x , y ) + {ϕ}_{pq 0} ( x , y ) ,$$
where x and y are spatial coordinates of the photodetector, Δk is a laser frequency modulation range, k(1) is an initial laser wave number, Iₚ and I_{q} are reflection intensities of p^{th} and q^{th} layers of the measured material, Λ_{pq} is an optical path difference between the p^{th} and q^{th} layers, φ_{pq0} is an initial phase difference between the p^{th} and q^{th} layers, and n=1, 2, . . . , N where N is a total number of frames captured by the photodetector.
